(19) United States
(12) Patent Application Publication
(10) Pub. No.: US 2013/0266149 A1
(43) Pub. Date: Oct. 10, 2013

(54) COMMUNICATION SYSTEM AND METHOD HAVING ECHO-CANCELLING MECHANISM

(71) Applicant: Tai-Lin WU, New Taipei City (TW)

(72) Inventor: Tai-Lin WU, New Taipei City (TW)

(73) Assignee: Quanta Computer Inc., Taoyuan Shien (TW)

(21) Appl. No.: 13/596,479

(22) Filed: Aug. 28, 2012

(30) Foreign Application Priority Data
Apr. 9, 2012 (TW) 101112475

(51) Int. Cl. H04B 3/20

(52) U.S. Cl. 381/66

(57) ABSTRACT

A communication system having echo-cancelling mechanism is provided. The communication system communicates with a remote communication device. The communication system comprises a computer system end, a digital playback device, a sound-receiving module, a digital-to-analog (D/A) converter and a digital processing module. The computer system end receives a digital signal from the remote communication device. The digital playback device plays the digital signal to generate a sound signal. The sound-receiving module generates an analog audio signal comprising the sound signal. The D/A converter receives a digital sound signal of the digital signal and converts the digital sound signal to an analog sound signal. The digital processing module performs an echo-cancelling process on the analog audio signal according to the analog sound signal.

### RELATED APPLICATIONS

This application claims priority to Taiwan Application Serial Number 101112475, filed Apr. 09, 2012, which is herein incorporated by reference.

### BACKGROUND

1. Technical Field

The present disclosure relates to communication technology. More particularly, the present disclosure relates to a communication system and a method having an echo-cancelling mechanism.

2. Description of Related Art

FIG. 1 is a block diagram of a conventional communication system 1. The communication system 1 (the user itself) is used to communicate with other remote communication devices (other participants not shown). The communication system 1 includes a computer system end 100, a digital playback device 102, a sound-receiving module 104, a speaker 106 and a digital processing module 108. The digital playback device 102 can be a liquid crystal display (LCD) TV or a LCD monitor. The sound-receiving module 104 can be a microphone for generating an analog audio signal 105.

The speaker 106 can only play analog signals. Hence, the digital sound signal from the computer system end 100 has to be converted to an analog sound signal 101 by using a built-in digital-to-analog (D/A) converter such that the speaker 106 is able to play the analog sound signal 101 to generate a sound signal 103 in analog form from the other participants.

Besides, the transmission of the audio and the video signal simultaneously between the conventional computer system 100 and the digital playback device 102 (LCD TV) is usually implemented through a single cable (e.g. HDMI). However, the built-in speaker (not shown) of the LCD TV can only play the analog sound signal while the screen of the LCD TV can directly play the digital video signal. The digital video signal and the analog sound signal cannot be transmitted simultaneously through a single cable. Therefore, in the conventional design, the received digital sound signal is converted to the analog sound signal 101 by the built-in D/A converter first and the analog sound signal 101 is further converted back to the digital form subsequently by an analog-to-digital converter such that the digital sound signal and the digital video signal can be simultaneously transmitted to the digital playback device 102 through the cable (e.g. HDMI). Then, the digital video signal is directed displayed by the screen of the LCD TV. However, the digital sound signal has to be converted to the analog form again by the build-in D/A converter in the digital playback device 102 for being played by the build-in speaker in the digital playback device 102 to generate the sound signal 103.

The communication system 1 can use the modules described above to convert the sound and/or image of the user in the analog form into the digital form for transmission. The sound and/or image signal can be played by the speaker 106 only in the audio communication or can be played by the digital playback device 102 in the videoconference using both the video and the audio signals. However, no matter which kind of communication is used, the echo phenomenon is generated since the analog audio signal 105 picked up by the sound-receiving module 104 comprises the sound signal 103 (i.e. from the other participants of the communication played by the speaker 106 or the digital playback device 102, which is undesired) and the voice of the user itself (the user audio signal 107, which is desired). Similarly, the sound-receiving module of the other participants will receive both of the sounds as well such that each of the participants can hear the voice of itself, which is an unpleasant effect.

In order to overcome the above issues, the current echo-cancelling technology generates a duplication of the analog sound signal 101 (processed by D/A conversion once) as a reference signal to make comparison with the analog audio signal 105 received by the sound-receiving module 104 to further cancel the sound signal 103 comprised in the analog audio signal 105. However, from the above description, it is known that the sound signal 103 included in the analog audio signal 105 is distorted since it is generated from a plurality of conversions (processed with D/A conversions twice and A/D conversion once). The efficiency of the echo-cancelling process decreases a lot.

Accordingly, what is needed is a communication system and a method having an echo-cancelling mechanism to efficiently cancel the annoying echo phenomenon.

### SUMMARY

An aspect of the present disclosure is to provide a communication system having an echo-cancelling mechanism, wherein the communication system communicates with a remote communication device, the communication system comprises a computer system end, a digital playback device, a sound-receiving module, a first digital-to-analog (D/A) converter and a digital processing module. The computer system end receives a digital signal from the remote communication device. The digital playback device plays the digital signal to generate a sound signal. The sound-receiving module generates an analog audio signal comprising the sound signal. The first digital-to-analog converter receives a digital sound signal of the digital signal and converts the digital sound signal to an analog sound signal. The digital processing module performs an echo-cancelling process on the analog audio signal according to the analog sound signal.

Another aspect of the present disclosure is to provide a communication method having an echo-cancelling mechanism, wherein the communication method is used in a communication system that communicates with a remote communication device. The communication method comprises the steps outlined below. A digital signal is received from the remote communication device. The digital signal is played to generate a sound signal. An analog audio signal comprising the sound signal is generated. A digital sound signal of the digital signal is received and the digital sound signal is converted to an analog sound signal. An echo-cancelling process is performed on the analog audio signal according to the analog sound signal.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a conventional communication system;

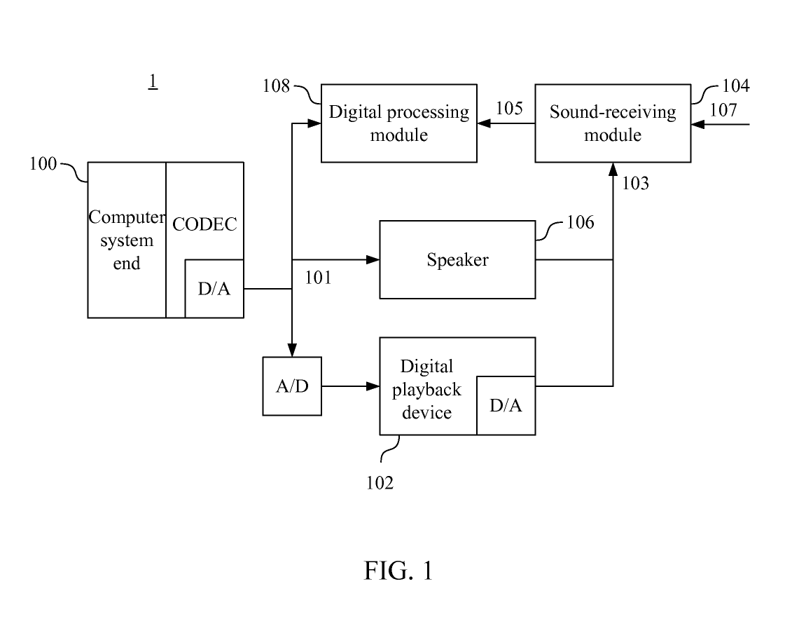

FIG. 2 is a block diagram of a communication system in an embodiment of the present disclosure;

FIG. 3 is a block diagram of a communication system in another embodiment of the present disclosure; and

FIG. 4 is a flow chart of a communication method in an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

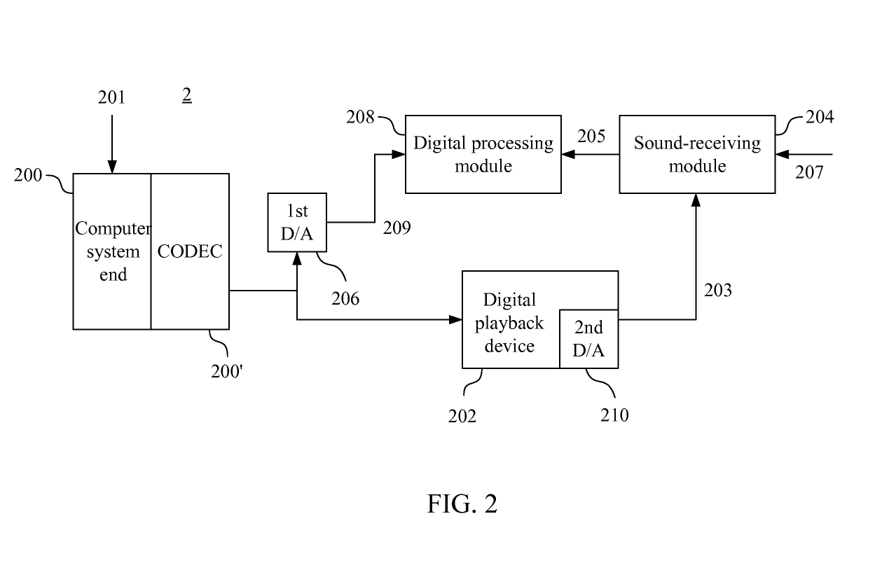

FIG. 2 is a block diagram of a communication system 2 in an embodiment of the present disclosure. The communication system 2 (the user itself) is used to communicate with other remote communication devices (other participants that are not shown). The communication system 2 includes a computer system end 200, a digital playback device 202, a sound-receiving module 204, a first digital-to-analog converter (depicted as 1st D/A in FIG. 2) 206 and a digital processing module 208.

In an embodiment, the communication system 2 or a remote communication device can be a computer or a mobile phone that is able to perform videoconference including the transmission of the audio signal and the video signal with others.

The computer system end 200 (e.g. a processor or a chipset) is used to process the digital signal 201. The digital signal 201 can be the audio/video signal received from one of the remote communication devices of the other participants through the network. In an embodiment, the computer system end 200 comprises a codec (encoder/decoder) 200′ to process, encode or decode the digital signal 201. In an embodiment, the digital signal 201 is a digital video/audio signal (or is called a digital video conferencing signal) including the sound part and the image part, such as the video conferencing signal from other participants or the user itself. The computer system end 200 can separate the digital signal 201 into a digital video signal and a digital sound signal (not shown).

The digital playback device 202 can play the digital signal 201. The digital playback device 202 can be a liquid crystal display (LCD) TV having a speaker to both display the image and play the sound. In an embodiment, the digital playback device 202 further comprises a second digital-to-analog converter (depicted as 2nd D/A in FIG. 2) 210 to convert the digital sound signal included in the digital signal 201 into the analog sound signal since the speaker can only play the signals in the analog form. Subsequently, the screen of the digital playback device 202 displays the digital video signal and the speaker of the digital playback device 202 plays the analog sound signal respectively. The sound signal 203 is further generated according to the analog sound signal played by the digital playback device 202. In other embodiments, the digital playback device 202 can also be an audio playback device (e.g. a speaker) to simply generate the sound signal 203 according to the digital signal 201 and 2nd D/A.

The sound-receiving module 204 can be a microphone for receiving the sound in the environment to generate an analog audio signal 205. In an embodiment, the sound in the environment includes the voice of the user (the user audio signal 207) and the sound signal 203 from the other participants of the communication played by the digital playback device 202. It is noted that the sound signal 203 received by the sound-receiving module 204 is the target signal that needs to be cancelled in the present disclosure to avoid the sound signal 203 played by the digital playback device 202 being received by the communication system 2.

In order to address the above issues, the communication system 2 comprises the first digital-to-analog converter 206 for converting the digital sound signal of the digital signal 201 into the analog sound signal 209. The first digital-to-analog converter 206 further transmits the analog sound signal 209 to the digital processing module 208. Accordingly, the digital processing module 208 can perform the echo-cancelling process on the analog audio signal 205 in accordance to the analog sound signal 209. More specifically, the digital processing module 208 can use the analog sound signal 209 as a reference to search and cancel the part of the sound signal 203 included in the analog audio signal 205 generated by the digital playback device 202 to perform the echo-cancelling process. Furthermore, the echo-cancelled analog audio signal 205 is further transmitted to the computer system end 200 from the digital processing module 208 and is further transmitted to the remote communication devices (other participants). In an embodiment, a few processes such as encoding and analog-to-digital conversion are performed on the echo-cancelled analog audio signal 205 by the codec 200′ such that the computer system end 200 could transmit the processed analog audio signal 205 in digital form. In an embodiment, the digital processing module 208 includes a built-in analog-to-digital converter to convert the analog sound signal 209 and the sound signal 203 into the digital form before performing the echo-cancelling process.

From the above description, it is known that the sound signal 203 from the digital signal 201 is converted from the digital form to the analog form only once by the second digital-to-analog converter 210, and the analog sound signal 209 used as the reference signal is also converted from the digital form to the analog form once from the digital signal 201. Therefore, the analog sound signal 209 is highly similar to the sound signal 203. The efficiency of the echo-cancelling process in the present disclosure using the analog sound signal 209 as the reference signal is higher than the conventional echo-cancelling technologies. The communication system 2 of the present disclosure can cancel the echo phenomenon caused by the sound signal 203 included in the analog audio signal 205 more efficiently.

Besides, the sound signal 203 is generated after the transmission from the computer system end 200 to the digital playback device 202, processed with the digital-to-analog conversion of the digital signal 201, and then received by the sound-receiving module 204, such that it is included in the analog audio signal 205. The processing path of the sound signal 203 is longer than the analog sound signal 209 that is only processed by the first digital-to-analog converter 206. Therefore, the timing of generation of the analog audio signal 205 is delayed relative to that of the analog sound signal 209. In other words, the analog sound signal 209 is transmitted to the digital processing module 208 prior to the analog audio signal 205. If the delay time is too long, i.e. the difference of the reception time between the analog sound signal 209 and the analog audio signal 205 is too large, the sound signal 203 may be identified as a signal different from the analog sound signal 209 and the echo-cancelling process is not performed.

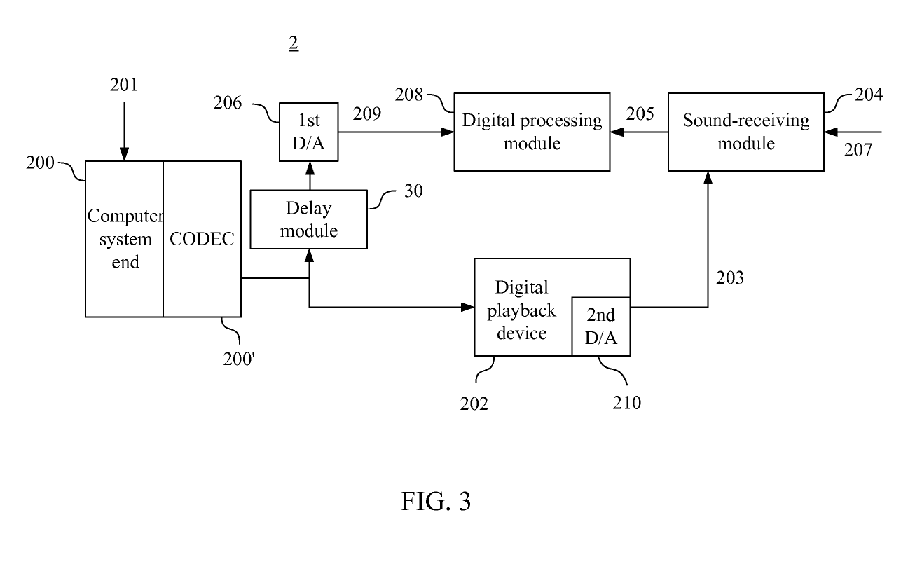

FIG. 3 is a block diagram of a communication system 2 in another embodiment of the present disclosure. In order to address the above issue, the communication system 2 of the present embodiment further comprises a delay module 30 disposed at a front end of the first digital-to-analog converter 206 such that the timing of the transmission of the digital sound signal of the digital signal 201 to the first digital-to-analog converter 206 is delayed. After the first digital-to-analog converter 206 receives the delayed digital sound signal, the delayed digital sound signal is further converted to the analog form to generate the analog sound signal 209. The timing of the reception of the analog sound signal 209 to the digital processing module 208 could be closer to the timing of the reception of the sound signal 203 to the digital processing module 208 by using the delay module 30. Therefore, the analog sound signal 209 can be used as the reference signal to perform the echo-cancelling process. It is noted that in other embodiments, the delay module 30 can be disposed at the back end of the first digital-to-analog converter 206 to delay the analog sound signal 209 generated by the first digital-to-analog converter 206.

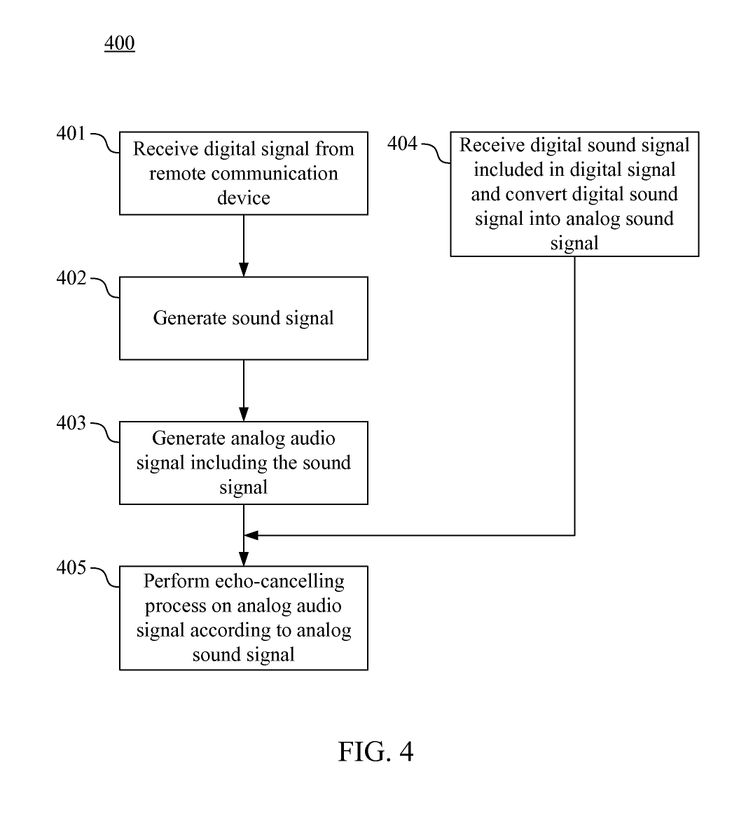

FIG. 4 is a flow chart of a communication method 400 in an embodiment of the present disclosure. The communication method 400 can be used in the communication system 2 depicted in FIG. 2 or FIG. 3. The communication method 400 comprises the steps outlined below. The steps are not recited in the sequence in which the steps are performed. That is, unless the sequence of the steps is expressly indicated, the sequence of the steps is interchangeable, and all or part of the steps may be simultaneously, partially simultaneously, or sequentially performed.

In step 401, the computer system end 200 receives the digital signal 201. In an embodiment, the computer system end 200 separates the digital signal 201 into a digital sound signal and a digital video signal.

In step 402, the digital playback device 202 converts the digital sound signal included in the digital signal 201 into the analog form and plays the converted signal to generate the sound signal 203. In an embodiment, the digital sound signal is converted to the sound signal 203 by the digital-to-analog converter.

In step 403, the sound-receiving module 204 generates the analog audio signal 205 that includes the sound signal 203 and transmits the analog audio signal 205 to the digital processing module 208.

In step 404, the first digital-to-analog converter 206 receives the digital sound signal included in the digital signal 201 and converts the digital sound signal into the analog sound signal 209. In an embodiment, the analog sound signal 209 is generated by the digital-to-analog converter and is transmitted to the digital processing module 208. It is noted that the step 404 and the step 401 can be performed simultaneously.

In step 405, the digital processing module 208 performs the echo-cancelling process on the analog audio signal 205 according to the analog sound signal 209.

In an embodiment, the communication system 2 further comprises a delay module 30 to delay the digital sound signal (or the analog sound signal 209).

In summary, the communication system 2 of the present disclosure can increase the similarity of the sound signal 203 and the analog sound signal 209 and further make the timings of the reception of the two signals to the digital processing module 208 are close to each other. Hence, the digital processing module 208 will not determine the above two signals to be unrelated. The efficiency of the echo-cancelling process can thus be increased.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A communication system having an echo-cancelling mechanism, wherein the communication system communicates with a remote communication device, the communication system comprises:
a computer system end for receiving a digital signal from the remote communication device;
a digital playback device for playing the digital signal to generate a sound signal;
to a sound-receiving module for generating an analog audio signal comprising the sound signal;
a first digital-to-analog (D/A) converter for receiving a digital sound signal of the digital signal and converting the digital sound signal to an analog sound signal; and
a digital processing module for performing an echo-cancelling process on the analog audio signal according to the analog sound signal.

2. The communication system of claim 1, further comprising a delay module for delaying the digital sound signal.

3. The communication system of claim 1, further comprising a delay module for delaying the analog sound signal.

4. The communication system of claim 1, wherein the digital playback device comprises a second digital-to-analog converter to convert the digital sound signal into an analog form.

5. The communication system of claim 1, wherein the communication system comprises a computer or a mobile phone.

6. A communication method having an echo-cancelling mechanism, wherein the communication method is used in a communication system that communicates with a remote communication device, the communication method comprises:
receiving a digital signal from the remote communication device;
playing the digital signal to generate a sound signal;
generating an analog audio signal comprising the sound signal;
receiving a digital sound signal of the digital signal and converting the digital sound signal to an analog sound signal; and
performing an echo-cancelling process on the analog audio signal according to the analog sound signal.

7. The communication method of claim 6, further comprising a step of delaying the digital sound signal.

8. The communication method of claim 6, further comprising a step of delaying the analog sound signal.

9. The communication method of claim 6, wherein in the step of playing the digital signal to generate a sound signal further comprises converting the digital signal into an analog form.

10. The communication method of claim 6, further comprising a step of transmitting the analog audio signal to the remote communication device after performing the echo-cancelling process.
